(19) United States
(12) Patent Application Publication
(10) Pub. No.: US 2022/0363890 A1
(43) Pub. Date: Nov. 17, 2022

(54) POLYESTER RESIN COMPOSITION FOR INJECTION MOLDING, METHOD FOR MANUFACTURING THE SAME, AND INJECTION MOLDED PRODUCT USING THE SAME

(71) Applicant: NAN YA PLASTICS CORPORATION, Taipei (TW)

(72) Inventors: TE-CHAO LIAO, TAIPEI (TW); CHUN-CHE TSAO, TAIPEI (TW); Yueh-Shin Liu, Taipei City (TW)

(21) Appl. No.: 17/504,473

(22) Filed: Oct. 18, 2021

(30) Foreign Application Priority Data
May 11, 2021 (TW) 110116876

(51) Int. Cl. C08L 67/00

(52) U.S. Cl. CPC C08L 67/00; C08L 2205/02; C08L 2207/20

(57) ABSTRACT

A polyester resin composition for injection molding, a method for manufacturing the same, and an injection molded product using the same are provided. An inherent viscosity (IV) of the polyester resin composition is between 0.5 dL/g and 0.85 dL/g. The polyester resin composition, based on a total weight thereof being 100 wt %, includes: 50 wt % to 80 wt % of virgin polyester chips and 20 wt % to 50 wt % of modified recycled polyester chips. The modified recycled polyester chips include 65 wt % to 72 wt % of terephthalic acid, 28 wt % to 31 wt % of ethylene glycol, and 0.1 wt % to 5 wt % of isophthalic acid.

### CROSS-REFERENCE TO RELATED PATENT APPLICATION

This application claims the benefit of priority to Taiwan Patent Application No. 110116876, filed on May 11, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyester resin composition for injection molding, a method for manufacturing the same, and an injection molded product using the same, and more particularly to a polyester resin composition, a method for manufacturing the same, and an injection molded product (such as storage equipment, hooks, containers, and electrical parts) that has a high flow ratio; more specifically, modified resin chips for injection molding a PET storage box are adopted.

### BACKGROUND OF THE DISCLOSURE

In recent years, usage of plastics has increased significantly, and as a result, a large amount of plastic waste is produced. Since the plastics are not easily degraded, recycling of the plastics and how to process the plastics after recycling have become particularly important issues.

Polyethylene terephthalate (PET) makes up a major portion of recycled plastics, and recycled PET plastics take up about 52.4% of a total amount of the recycled plastics. In order to deal with such a large amount of recycled PET plastics, researchers in the relevant field have to dedicate themselves to developing a method for processing the recycled PET plastics.

Out of the current techniques, the most common method to regenerate PET is through a physical (mechanical) manner. The recycled PET plastics that have been washed clean are firstly shredded to pieces and melted under high temperature, and then are extruded by an extruder to produce recycled PET chips (also called r-PET).

To address environmental concerns and to ensure that PET products contain more eco-friendly recycled PET chips, a large amount of high-quality recycled PET chips is required. In the current industry, the PET recycling is mostly carried out by way of physical recycling. However, functional components (such as a slipping agent and an electrostatic pinning additive) are not allowed to be added, during a manufacturing process, to recycle chips that are produced through physical recycling. Therefore, it is necessary to use additional virgin (not regenerated) PET chips for additionally adding the above-mentioned functional components.

However, such an approach will cause a usage rate of the recycled PET chips contained in the PET products to decrease. In order to maintain performance of the PET products, an added amount of the recycled PET chips is approximately less than 20%. That is to say, it is not possible to fully utilize the recycled PET chips to manufacture new PET products using the current techniques. If the usage rate of the recycled PET chips is too low, it may not be possible to satisfy environmental standards, such that an eco-label cannot be obtained. Moreover, as virgin PET chips that are newly used in the process of manufacturing the PET products subsequently become the recycled PET plastics that require processing, a problem of recycling and reusing would still arise.

Therefore, how to improve a composition ratio, so as to increase the usage rate of the recycled PET chips, reduce the virgin PET chips that are additionally added, and maintain the performance of the PET products, has become one of the important issues to be solved in the industry.

### SUMMARY OF THE DISCLOSURE

In response to the above-referenced technical inadequacies, the present disclosure provides a polyester resin composition for injection molding, a method for manufacturing the same, and an injection molded product using the same.

In one aspect, the present disclosure provides a polyester resin composition for injection molding. An inherent viscosity (IV) of the polyester resin composition is between 0.5 dL/g and 0.85 dL/g. The polyester resin composition, based on a total weight thereof being 100 wt %, includes: 50 wt % to 80 wt % of virgin polyester chips and 20 wt % to 50 wt % of modified recycled polyester chips. The modified recycled polyester chips include 65 wt % to 72 wt % of terephthalic acid, 28 wt % to 31 wt % of ethylene glycol, and 0.1 wt % to 5 wt % of isophthalic acid.

In certain embodiments, a crystallinity of the polyester resin composition ranges from 10% to 20%.

In certain embodiments, a tensile strength of the polyester resin composition ranges from 54.0 MPa to 64.7 MPa.

In certain embodiments, an impact resistance of the polyester resin composition ranges from 2.8 kg-cm/cm to 3.6 kg-cm/cm.

In another aspect, the present disclosure provides a method for manufacturing a polyester resin composition for injection molding. The method includes: providing modified recycled polyeter chips, in which the modified recycled polyester chips include 65 wt % to 72 wt % of terephthalic acid, 28 wt % to 31 wt % of ethylene glycol, and 0.1 wt % to 5 wt % of isophthalic acid; and mixing the modified recycled polyester chips with virgin polyester chips to form an injection molding material.

In certain embodiments, based on a total weight of the polyester resin composition being 100 wt %, a content of the modified recycled polyester chips ranges from 20 wt % to 50 wt %.

In certain embodiments, based on a total weight of the polyester resin composition being 100 wt %, a content of the virgin polyester chips ranges from 50 wt % to 80 wt %.

In certain embodiments, the modified recycled polyester chips including physically regenerated polyester chips and or chemically regenerated polyester chips.

In yet another aspect, the present disclosure provides an injection molded product. The injection molded product is formed by melt injection molding of the above-mentioned polyester resin composition of the present disclosure.

Therefore, in the polyester resin composition for injection molding, the method for manufacturing the same, and the injection molded product using the same provided by the present disclosure, by virtue of “the modified recycled polyester chips including 65 wt % to 72 wt % of terephthalic acid, 28 wt % to 31 wt % of ethylene glycol, and 0.1 wt % to 5 wt % of isophthalic acid”, the crystallinity and fluidity of the polyester resin composition can be effectively controlled, and a usage amount of recycled polyester chips can be increased, so as to reduce a manufacturing cost.

More specifically, by adjusting a composition ratio of the modified recycled polyester chips, the inherent viscosity (IV) thereof can be effectively improved to be between 0.5 dL/g and 0.85 dL/g, and a mold temperature can be lowered to below 60° C. In a process for manufacturing the modified recycled polyester chips, a crystallization time of terephthalic acid and ethylene glycol can be delayed to facilitate physical properties and preparation of the modified recycled polyester chips. Further, while an amount of the virgin polyester chips used in the polyester resin composition is effectively reduced, the same physical properties can still be achieved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings in which:

FIG. 1 is a flowchart of a method for manufacturing a polyester resin composition for injection molding according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

It should be noted that, the terms “polyester”, “polyester material”, “polyester resin”, etc., can refer to any type of polyester, but especially to aromatic polyester. In particular, polyester derived from terephthalic acid and ethylene glycol, i.e., polyethylene terephthalate (PET), is referred to herein.

A future trend of the market is gradually directed toward circular economy and plastic recycling. Therefore, how to increase an added amount of recycled PET chips in products, maintain mechanical properties and processability of the products, and control a material cost are important issues to be solved in the field of plastic recycling.

A polyester resin composition can be used in various applications, such as containers. The polyester resin composition can form different objects usually by injection molding, extrusion molding, or use of a mold. For example, in a process of the injection molding, the polyester resin composition is melted by heating or the like. After a melted composition is injected into the mold, the melted composition is cooled and solidified to produce a molded body.

The polyester resin composition of the present disclosure can be used to produce PET chips for manufacturing injection molded products (such as storage equipment, hooks, containers, and electrical parts) that have a high flow ratio. The polyester resin composition has an inherent viscosity (IV) of between 0.5 dL/g and 0.85 dL/g, and characteristics that include a high flow ratio and a low shrinkage rate.

In one aspect, the present disclosure provides a polyester resin composition for injection molding. An inherent viscosity (IV) of the polyester resin composition is between 0.5 dL/g and 0.85 dL/g. The polyester resin composition, based on a total weight thereof being 100 wt %, includes: 50 wt % to 80 wt % of virgin polyester chips and 20 wt % to 50 wt % of modified recycled polyester chips. The modified recycled polyester chips include 65 wt % to 72 wt % of terephthalic acid, 28 wt % to 31 wt % of ethylene glycol, and 0.1 wt % to 5 wt % of isophthalic acid.

In certain embodiments, a crystallinity of the polyester resin composition ranges from 10% to 20%.

In certain embodiments, a tensile strength of the polyester resin composition ranges from 54.0 MPa to 64.7 MPa.

In certain embodiments, an impact resistance ranges from 2.8 kg-cm/cm to 3.6 kg-cm/cm.

[Virgin Polyester Chips]

Virgin polyester chips refer to conventional new polyester chips. Preferably, the virgin polyester chips have an inherent viscosity (IV) of between 0.64 and 0.8 dL/g. Based on a total weight of the polyester resin composition being 100 wt %, a content of the virgin polyester chips ranges from 50 wt % to 80 wt %. More preferably, the content can be from 50 wt % to 70 wt %, from 50 wt % to 60 wt %, or 50 wt %. By virtue of the technical characteristics of the present disclosure, an added amount of the virgin polyester chips can be significantly decreased, so as to address environmental concerns.

[Modified Recycled Polyester Chips]

Specifically, recycled polyester chips can include physically regenerated polyester chips and/or chemically regenerated polyester chips, and detailed descriptions thereof will be provided below.

Firstly, to obtain the recycled polyester chips that are reusable, a recycling method for polyester resins includes: collecting discarded polyester resin materials of all types. The discarded polyester resin materials are then sorted by type, color, and intended purpose. Further, these discarded polyester resin materials are pressed and baled to be shipped to waste treatment facilities. In the present embodiment, the discarded polyester resin materials are recycled PET bottles. However, the present disclosure is not limited thereto.

Next, other parts (e.g., bottle tops, labels, and adhesives) of the discarded polyester resin materials would be removed. When such parts are removed from the discarded polyester resin materials, the discarded polyester resin materials are cut and shredded, and then bottle rims, gaskets, and bottle bodies of different materials are separated from each other by flotation. The discarded polyester resin materials that are shredded are then dried. In this way, the recycled polyester material which has been processed, e.g., recycled PET (r-PET) bottle chips, can be obtained, so as to facilitate a subsequent manufacturing process.

Moreover, in addition to recycled polyester materials such as PET bottles, recycled scraps of film materials, re-granulated chips of recycled film materials containing release agents, or fiber spinning scraps can also be selected for use. After being crushed and melted, recycled materials (such as the recycled scraps of the film materials, recycled release films and fiber scraps) are reproduced into the recycled polyester chips. In this way, a low cost can be achieved.

It is worth mentioning that, in other embodiments of the present disclosure, the recycled polyester material can be, for example, a processed recycled polyester material directly obtained through purchase, so as to proceed with the subsequent manufacturing process.

In the embodiment of the present disclosure, the method for manufacturing the recycled polyester material includes: physically reproducing a part of the recycled polyester material (e.g., PET bottle chips, films and fibers) and granulating the same to obtain a plurality of physically recycled polyester chips, and chemically reproducing another part of the recycled polyester material and granulating the same to obtain a plurality of chemically recycled polyester chips.

A physical reproduction process includes: cutting the recycled polyester material (such as bottle chips) into pieces, and then the pieces are melted to form a melted mixture. The melted mixture is extruded by a single-screw extruder or a twin-screw extruder, and is then granulated to obtain the physically regenerated polyester chips. A rotation speed of a pelletizing machine is from 200 rpm to 1000 rpm, and a screw diameter is set at 2.5 mm.

In one embodiment of the present disclosure, the physically regenerated polyester chips include physically regenerated regular polyester chips. The physically regenerated regular polyester chips are polyester chips prepared through the physical reproduction process and no additive is added during the physical reproduction process. In the present embodiment, components of the physically regenerated regular polyester chips include regenerated polyethylene terephthalate.

In addition, in the physical reproduction process, functional additives (such as slipping agents, coloring agents, or matting agents) can be added into the melted mixture, so as to prepare physically regenerated modified polyester chips with different functions.

For example, the slipping agents can be, but are not limited to, silicon dioxide, polystyrene, polymethylmethacrylate, silicone rubber, acrylic, or any combination thereof. A particle size of the slipping agents is smaller than 2 μm. In the present embodiment, the slipping agents are sphere-shaped, so that the slipping agents can have better transparency. Physically regenerated slipping polyester chips can be prepared by adding the slipping agents into the melted mixture. In the present embodiment, components of the physically regenerated slipping polyester chips include regenerated polyethylene terephthalate and slipping agents.

For example, the coloring agents can be, but are not limited to, coloring additives, carbon black, titanium dioxide, barium sulfate, or calcium carbonate. Physically regenerated color polyester chips can be prepared by adding the coloring agents into the melted mixture. In the present embodiment, components of the physically regenerated color polyester chips include regenerated polyethylene terephthalate and coloring agents.

For example, the matting agents can be, but are not limited to, silicon dioxide, organics, silicon rubber, acrylic, or any combination thereof. Physically regenerated matting polyester chips can be prepared by adding the matting agents into the melted mixture. In the present embodiment, components of the physically regenerated matting polyester chips include regenerated polyethylene terephthalate and matting agents.

Specifically, the physically regenerated modified polyester chips are prepared by steps below. The recycled polyester material is melted to obtain a first melted mixture. Polybutylene terephthalate is added into the first melted mixture to form a second melted mixture. The second melted mixture is molded to obtain the physically regenerated modified polyester chips having a main component of regenerated polyethylene terephthalate. The physically regenerated modified polyester chips further include polybutylene terephthalate. Based on a total weight of the physically regenerated polyester chips being 100 wt %, 0 wt % to 30 wt % of polybutylene terephthalate is included in the physically regenerated modified polyester chips.

A chemical reproduction process includes the following steps. The recycled polyester material (such as bottle chips) is cut into pieces, and then put in a chemical depolymerizing solution. Polyester molecules are depolymerized into polyester monomers composed of a diacid unit and two diol units, such as bis(2-hydroxyethyl) terephthalate (BHET) or oligomers, such that an oligomer mixture is formed. Subsequently, the oligomer mixture is isolated, purified, repolymerized, and then granulated to obtain the chemically regenerated polyester chips. In the present embodiment, a main component of the chemically regenerated polyester chips is regenerated polyethylene terephthalate.

More specifically, the chemical depolymerizing solution can be water, methanol, ethanol, ethylene glycol, diethylene glycol or any combination thereof. However, the present embodiment is not limited thereto. For example, water is used for hydrolysis, and methanol, ethanol, ethylene glycol, diethylene glycol are used for alcoholysis. In an exemplary embodiment, the chemical depolymerizing solution includes ethylene glycol.

In addition, in the chemical reproduction process, the functional additives mentioned above (such as slipping agents, coloring agents, and matting agents) can be added into the oligomer mixture. After repolymerization, chemically regenerated modified polyester chips with different functions can be obtained.

[Modified Recycled Polyester Chips]

Due to mechanical properties and processability, an added amount of the recycled polyester chips cannot be increased in the polyester resin composition. Further, there is difficulty in controlling the recycled polyester materials on the market, and improving material properties thereof. Therefore, by adjusting a composition of the modified recycled polyester chips, the crystallinity and fluidity of the polyester resin composition can be effectively controlled, and a manufacturing cost can be reduced.

Specifically, the modified recycled polyester chips include 65 wt % to 72 wt % of terephthalic acid, 28 wt % to 31 wt % of ethylene glycol, and 0.1 wt % to 5 wt % of isophthalic acid. By adjusting an amount of isophthalic acid, a crystallization time of terephthalic acid and ethylene glycol can be delayed, so as to facilitate preparation of the modified recycled polyester chips.

More specifically, depending on practical requirements, ethylene glycol can also be selected from aliphatic diol groups, such as 1,3-propanediol, 1,4-butanediol, 1,5-pentanediol, 1,6-hexanediol, diethylene glycol, propylene glycol, and neopentyl glycol.

Through a specific ratio of the modified recycled polyester chips, the crystallinity of the polyester resin composition can be controlled to be between 10% and 20%, and the inherent viscosity (IV) of the polyester resin composition is between 0.5 dL/g and 0.85 dL/g, which can be applied to molding products with a high flow ratio and a low shrinkage.

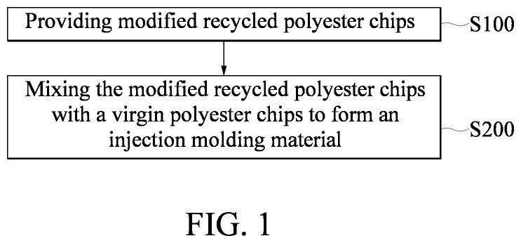

Referring to FIG. 1, the present disclosure further provides a method for manufacturing a polyester resin composition for injection molding. The method includes: providing modified recycled polyester chips (S100), and mixing the modified recycled polyester chips with virgin polyester chips to form an injection molding material (S200).

More specifically, the step S100 further includes: cutting recycled polyester materials (such as PET bottle flakes and recycled molding materials), and melting the cut bottle flakes to form a melted mixture, or commercially purchasing recycled polyester chips that have been processed.

The injection molding material prepared in the aforementioned step S200 by mixing the modified recycled polyester chips with the virgin polyester chips can be processed and molded into a polyester chip state, so as to facilitate storage and preservation.

In addition, the method may further include an injection molding preparation step (S300). The aforementioned injection molding material is introduced into an injection molding machine having a mold. The injection molding material is plasticized into a melt phase in the injection molding machine, and is injected into the mold to form a molded product. Then, a cooling treatment is applied to the molded product. By mixing the modified recycled polyester chips and the virgin polyester chips, the intrinsic viscosity (IV) is effectively improved to be between 0.5 dL/g and 0.85 dL/g, and a mold temperature can be lowered to below 40° C. Preferably, the mold temperature is from 25° C. to 40° C.

Preferably, based on a total weight of the polyester resin composition being 100 wt %, a content of the modified recycled polyester chips ranges from 20 wt % to 50 wt % and a content of the virgin polyester chips ranges from 50 wt % to 80 wt %.

Moreover, the present disclosure provides an injection molded product, which is formed by melt injection molding of the polyester resin composition of the present disclosure. For example, the injection molded product is an injection molded PET storage box formed by modified resin chips.

However, the above descriptions are merely examples for illustrative purposes and are not meant to limit the scope of the present disclosure.

### Preparation Embodiments

Referring to Table 1, a preparation embodiment of the modified recycled polyester chips of the present disclosure is provided. The composition in Table 1 is uniformly mixed by an internal mixer, and is then mixed and squeezed by the screw extruder and the pelletizing machine at a predetermined temperature, so as to form modified recycled polyester chips having a predetermined particle size. Preferably, the predetermined temperature is between 250° C. and 280° C., the rotation speed of the pelletizing machine is from 900 rpm to 1000 rpm, and the screw diameter is set at 2.5 mm. After mixing and squeezing, the modified recycled polyester chips having a granular shape and a particle size of between 2 mm and 3 mm are hot cut by a rotary knife. By adding isophthalic acid, the crystallization time of terephthalic acid and ethylene glycol can be delayed, which is beneficial for the modified recycled polyester chips.

TABLE 1

| | Preparation | Comparative Preparation |
|---|---|---|
| | Embodiment 1 | Embodiment 1 |
| Terephthalic acid (PTA) | 69 | 71 |
| Ethylene glycol (EG) | 29 | 29 |
| Isophthalic acid (IPA) | 2 | 0 |

### Embodiments

Referring to Table 2, a composition ratio of the polyester resin composition of the present disclosure and physical property tests of the injection molded products are shown. Raw material mixtures of the embodiments are uniformly mixed and formed according to the ratio listed in Table 2. By using an injection molding machine at a temperature of 40° C., the injection molded products are obtained.

TABLE 2

| | | | | | Comparative | |
|---|---|---|---|---|---|---|
| | Embodiment 1 | | Embodiment 2 | | Embodiment 1 | |
| Modified recycled polyester | 20 wt % of | | 50 wt % of | | 20 wt % of | |
| chips | Preparation | | Preparation | | Preparation | |
| | Embodiment 1 | | Embodiment 1 | | Comparative | |
| | | | | | Embodiment 1 | |
| Virgin polyester chips | 80 | wt % | 50 | wt % | 80 | wt % |
| Crystallinity | 14.8 | | 16.3 | | 16.2 | |
| Intrinsic viscosity (IV) | 0.8 | dl/g | 0.8 | dl/g | 0.8 | dl/g |
| Impact resistance (ASTM D256) | 3.2 | kg-cm/cm | 3.0 | kg-cm/cm | 3.0 | kg-cm/cm |
| Tensile Strength (ASTM D638) | 64.7 | MPa | 56.1 | MPa | 54.3 | MPa |
| Flexural strength (ASTM D790) | 96.7 | MPa | 90.7 | MPa | 90.8 | MPa |
| Flexural modulus (ASTM D790) | 2650 | MPa | 2590 | MPa | 2640 | MPa |

Compared with comparative embodiment 1, embodiment 1 and embodiment 2 using the modified recycled polyester chips of preparation embodiment 1 have better impact resistance, tensile strength, flexural strength and flexural modulus. Therefore, the embodiments of the present disclosure are suitable for use in the injection molded products (such as storage equipment, hooks, containers, and electrical parts) that have a high flow ratio.

### Beneficial Effects of the Embodiments

In conclusion, in the polyester resin composition for injection molding, the method for manufacturing the same, and the injection molded product using the same provided by the present disclosure, by virtue of “the modified recycled polyester chips including 65 wt % to 72 wt % of terephthalic acid, 28 wt % to 31 wt % of ethylene glycol, and 0.1 wt % to 5 wt % of isophthalic acid”, the crystallinity and fluidity of the polyester resin composition can be effectively controlled, and a usage amount of recycled polyester chips can be increased, so as to reduce a manufacturing cost.

Furthermore, by mixing the modified recycled polyester chips and the virgin polyester chips, the inherent viscosity (IV) of the polyester resin composition is effectively improved to be between 0.5 dL/g and 0.85 dL/g, and the mold temperature can be lowered to below 50° C. During the preparation of the modified recycled polyester chips, by adjusting the ratio, an addition of isophthalic acid can delay the crystallization time of terephthalic acid and ethylene glycol, so as to facilitate physical properties and the preparation of the modified recycled polyester chips.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A polyester resin composition for injection molding, wherein an inherent viscosity (IV) of the polyester resin composition is between 0.5 dL/g and 0.85 dL/g, and based on a total weight thereof being 100 wt %, the polyester resin composition comprises:
50 wt % to 80 wt % of virgin polyester chips; and
20 wt % to 50 wt % of modified recycled polyester chips, wherein the modified recycled polyester chips include 65 wt % to 72 wt % of terephthalic acid, 28 wt % to 31 wt % of ethylene glycol, and 0.1 wt % to 5 wt % of isophthalic acid.

2. The polyester resin composition according to claim 1, wherein a crystallinity of the polyester resin composition ranges from 10% to 20%.

3. The polyester resin composition according to claim 1, wherein a tensile strength of the polyester resin composition ranges from 54.0 MPa to 64.7 MPa.

4. The polyester resin composition according to claim 1, wherein an impact resistance of the polyester resin composition ranges from 2.8 kg-cm/cm to 3.6 kg-cm/cm.

5. A method for manufacturing a polyester resin composition for injection molding, comprising:
providing modified recycled polyester chips, wherein the modified recycled polyester chips include 65 wt % to 72 wt % of terephthalic acid, 28 wt % to 31 wt % of ethylene glycol, and 0.1 wt % to 5 wt % of isophthalic acid; and
mixing the modified recycled polyester chips with virgin polyester chips to form an injection molding material.

6. The method according to claim 5, wherein, based on a total weight of the polyester resin composition being 100 wt %, a content of the modified recycled polyester chips ranges from 20 wt % to 50 wt %.

7. The method according to claim 5, wherein, based on a total weight of the polyester resin composition being 100 wt %, a content of the virgin polyester chips ranges from 50 wt % to 80 wt %.

8. The method according to claim 5, wherein the modified recycled polyester chips include at least one of physically regenerated polyester chips and chemically regenerated polyester chips.

9. An injection molded product, characterized in that the injection molded product is formed by melt injection molding of the polyester resin composition as claimed in claim 1.
